(19) United States
(12) Patent Application Publication
(10) Pub. No.: US 2026/0274439 A1
(43) Pub. Date: Sep. 17, 2026

(54) PLACEMENT SYSTEM FOR AN AIRPORT FOR AUTOMATICALLY LOADING A FREIGHT CONTAINER WITH BAGGAGE ITEMS

(71) Applicant: AAT AUTOMATION GMBH, Karlsruhe (DE)

(72) Inventors: Daniel KAISER, Karlsruhe (DE); Roman KAISER, Karlsruhe (DE)

(73) Assignee: AAT AUTOMATION GMBH, Karlsruhe (DE)

(21) Appl. No.: 19/469,131

(22) PCT Filed: Sep. 25, 2023
(86) PCT No.: PCT/EP2023/076397

§ 371 Date: Sep. 25, 2025

(30) Foreign Application Priority Data
Mar. 29, 2023 (DE) 10 2023 107 924.7

(51) Int. Cl. B64F 1/36

(52) U.S. Cl. CPC B64F 1/368

(57) ABSTRACT

A placement system for an airport for automatically loading a freight container with baggage items from a feeder belt, including a feeder belt for feeding baggage items with one end; a placement machine for picking up the baggage items from the feeder belt and transporting them into the freight container; a handling area at the end of the feeder belt, into which the feeder belt extends and in which the placement machine is arranged; a container area arranged within the handling area, in which the freight container is to be arranged and which has a prescribed length and width; wherein the placement machine is arranged stationarily fixed outside of the container area; and the placement machine is arranged off-center to a longitudinal axis of the feeder belt and/or off-center to the perpendicular bisector of the longitudinal expansion of the container area for the freight container.

The present invention relates to a placement system for an airport for automatically loading a freight container with baggage items from a feeder belt. The invention further relates to a system comprising the placement system and a freight container as well as a corresponding method.

An automated conveyance and sorting of baggage items has already been taking place for aa long time at airports, in particular at larger airports. The units used for this purpose serve to transport baggage items from different entry points, for example from the check-in area, to a loading station in a targeted manner. The baggage items can here be correspondingly presorted by flight number and flight class. At the loading station, the baggage items are most often manually unloaded from a conveyor belt or feeder belt into suitable receptacles for transport to the aircraft. For example, these receptacles can be trolleys or containers or transport containers, which in part stand on wagons or trailers, and are in part self-rollable.

The baggage items are transported within the conveying units by means of technical equipment, such as belt conveyors or tray transport systems with an endless belt, in which transport trays are endlessly joined together. Suitable vehicles or ground vehicles are also used for transporting and conveying baggage items or containers.

As a rule, the baggage items are reloaded manually or by hand by people. The airport employees remove the baggage item from the belt conveyor and place or stack it in the corresponding freight container, which is then driven to the aircraft for which the baggage items are provided. The freight containers are filled and loaded on the one hand depending on the baggage items to be loaded, and on their size, weight and shape, along with the order in which they are delivered to the loading station. The arrangement and potentially sorting depend on the skill of the individual employees. This has an impact on the fill level of the freight containers, and thus on the loading capacity of the individual containers. The goal is to always optimize the latter.

Since a great deal of physical exertion is required of the employees while loading, the activity cannot be performed over a longer period of time without there having to be recovery breaks. This reduces the cycle time. The skill with which the employees fill the individual freight containers additionally influences the loading speed. Manual loading has proven to be rather expensive, for example due to high wages, vacations and sick leave.

For this reason, automation is the goal. It is here known that baggage is supplied above a freight container to be loaded, wherein the feeder belt ends essentially flush with the loading edge of the container. A placement machine or robot receives the delivered baggage item and loads it into the freight container lying thereunder. In this type of placement, however, it has been shown that several areas in the freight containers can only be filled with difficulty or not at all, in particular if the loading gap does not comprise the entire side of the freight container. In addition, it has been shown that the placement machine or robot must frequently travel or move on the floor. As a consequence, the placement machine must be mobile. During the use of robots, a 7-axis robot is here employed. However, the duration for loading a single baggage item is rather long due to the travel distance on the floor.

Therefore, there is a need for improving how baggage items are loaded and freight containers are filled.

The present object is achieved by a placement system with the features in claim 1, by a system with the features in claim 14, and by a method with the features in claim 15.

In a first aspect, the present invention relates to a placement system for an airport, so as to automatically load or place baggage items delivered by a feeder belt into a freight container. The baggage items are here preferably removed from the feeder belt.

The placement system comprises a feeder belt for feeding baggage items with an end, a placement machine for picking up the baggage items from the feeder belt and transporting them into the freight container, a handling area at the end of the feeder belt, into which the feeder belt extends and in which the placement machine is arranged, and a container area arranged within the handling area, in which the freight container is to be arranged and which has a prescribed length and width. The placement machine is arranged stationarily fixed outside of the container area. The placement machine is here arranged off-center to a longitudinal axis of the feeder belt and/or off-center to the perpendicular bisector of the longitudinal expansion of the container area for the freight container.

In another aspect, the invention relates to a system for an airport for automatically loading a freight container with baggage items from a feeder belt, comprising a placement system as described above and a freight container to be filled, which is positioned within the container area.

Additional aspects of the invention relate to a corresponding method and a computer program product with a program code for performing the steps of the method when executing the program code on a computer, or with a program code for controlling a placement system as described above. Another aspect relates to a storage medium on which a computer program is stored, which when executed on a computer causes the method described above to be implemented.

Preferred embodiments of the invention will be described in the dependent claims. It goes without saying that the features mentioned above and yet to be described below can be used not just in the respectively indicated combination, but rather in other combinations or alone as well, without departing from the framework of the present invention. In particular, the method and the computer program product can be designed according to the embodiments described in the dependent claims for the device.

According to the invention, the placement system is used at an airport for automatically loading baggage items from one free end of a feeder belt into a freight container. The freight container is here filled or loaded. The placement machine, which picks up or lifts the baggage items from the belt conveyor or feeder belt and to which the baggage items are fed, transports them into the freight container. The placement machine is here arranged in a handling area at the end of the feeder belt. Provided within the handling area is a container area, in which the freight container to be loaded is arranged if a loading is to take place. As a rule, the container area is similar in size to the freight container, as a rule somewhat larger, so that it can accommodate different types of freight containers.

As opposed to the placement machines or robots previously used in the airport area, the placement machine provided here is arranged stationarily fixed in the handling area according to the invention. It is arranged outside of the container area reserved for the containers. The placement machine is set up in a position defined beforehand, and is not moved on the floor or in the handling area. In other words, it is immobile.

The place or location of the placement machine is here selected in such a way as to have it be configured for handling baggage items in the easiest, fastest and least energy requiring manner possible. An optimized loading of baggage items from the feeder belt into the freight container here takes place.

According to the invention, the placement machine is thus arranged off-center to a longitudinal axis of the feeder belt. Additionally or alternatively, it is likewise arranged off-center to a perpendicular bisector of the longitudinal expansion of the container area. The movements of the placement machine for pick-up, transport and drop-off in the freight container were shown to be as small as possible in such a position. This results in a quick handling and quick reloading of the baggage item and placement on the freight container on the one hand, and also in a low energy consumption that accompanies the short movement paths.

On the one hand, the exact position of the placement machine depends on the spatial circumstances. As a rule, a prescribed and quite limited space is available. On the other hand, the remaining infrastructure at the airport should not have to be changed if at all possible.

The placement machine is preferably installed using the space and location at the airport that is otherwise employed for manually loading the freight container, and thus available, without requiring any major renovation measures at the airport. This advantage increases acceptance when introducing an automatic placement system at the airport.

Since the placement machine is stationary, the movement paths and speeds indicated here relate to a baggage holding unit or a baggage moving unit of the placement machine, which can be freely moved in space, at any rate within the handling area. This baggage moving unit holds or picks up the baggage and moves it from its position at the end of the feeder belt to its new position inside of the freight container.

In a preferred embodiment, the placement machine of the placement system is a robot. The robot is used to move the baggage items from the feeder belt into the container. The robot preferably has the baggage holding unit or baggage moving unit. The robot is especially preferably a stationary 6-axis robot with a robot arm, at whose end the baggage holding unit or baggage moving unit is arranged. The robot arm here preferably moves around a stationary base.

In a preferred embodiment, the robot has a grabber or a baggage rack. The grabber or baggage rack represents the baggage holding unit or baggage moving unit. In an especially preferred embodiment, the robot comprises a baggage rack, which is designed like a tray. The tray can in turn be designed like a belt conveyor or conveyor chain-like tablet, so that a baggage item picked up by the baggage rack can also be moved down from the baggage rack. The baggage rack can alternatively be a tablet-like element made of sheet metal, metal or plastic, which can be tilted so as to pick up or drop off a baggage item, e.g., convey it into the container.

In a preferred embodiment, the robot can be pivoted around a stationary vertical axis. Depending on its position within the handling area, a larger pivoting radius and movement radius may be necessary for the robot. The pivoting angle for loading the freight container is preferably at most 240°, with the pivoting angle further preferably being at most 180°. In this case, a rotation within a semicircle is possible. Depending on the embodiment and place of use, the pivoting angle can preferably be limited to 150°; it is further preferably at most 120°. In a likewise preferred embodiment, the pivoting angle measures a maximum of 90°.

A preferred embodiment of the placement system provides a position for the placement machine or the robot out of alignment with the guide belt. Alignment with the guide belt is viewed as the imagined extension of the guide belt or the conveyor system. As a consequence, then, the placement machine or robot is offset to the guide belt and the imagined continuation of the guide belt.

In a further preferred embodiment, the container area is arranged laterally to the guide belt, very preferably laterally to an alignment of the guide belt, wherein the container area preferably adjoins the end of the feeder belt laterally and out of alignment to the feeder belt, or also partially laterally overlaps with the feeder belt. The placement machine or robot is preferably arranged and positioned on the side of the alignment of the guide belt lying opposite the container area.

The position or attachment location of the placement machine is further preferably out of alignment to the guide belt and opposite the container area, wherein the placement machine is arranged at the end of the container area facing away from the feeder belt.

In order to be able to further increase the cycle time while loading the individual baggage items, the feeder belt is arranged at a provided and predetermined height in the handling area in a preferred embodiment of the placement system. The height of the feeder belt here determines the height of the baggage items on the belt. In this sense, the height of the feeder belt is understood as the height of the baggage item position on the belt.

In a preferred embodiment, the feeder belt is at least partially arranged in the handling area at a height less than the height of the upper side of the freight container.

When considering the height of the upper side of the freight container, it is not the absolute size or height of the freight container that is critical, but rather the height at which the upper side of the freight container is located when the freight container is arranged in the container area for loading and placement. For example, a freight container can be arranged on a rollable trailer or a rollable vehicle, which itself has a prescribed height. A typical freight container for baggage items in air freight or passenger transport is here taken as the basis.

In a preferred embodiment, the height of the feeder belt in the handling area is at least partially less than 80% of the height of the upper side of the freight container. The end of the feeder belt is preferably at the height corresponding to at most 80% of the height of the upper side of the freight container. In a very preferred embodiment, the height of the feeder belt is at most 50% of the height of the upper side of the freight container. In this nearly central feeding of the baggage items to the freight container, the movements to be performed by the placement machine over the entire placement process for filling a freight container are at the lowest.

A preferred embodiment of the placement system provides that the feeder belt be arranged in the handling area at least partially at a height larger than the height of the lower loading edge of the freight container. When viewing the height of the lower loading edge of the freight container, the height of the edge is here also critical once again when the freight container is in the container area for placement purposes.

The end of the feeder belt is preferably at a height larger than 25% of the height of the upper side of the freight container, with the feeder belt especially preferably being at a height larger than 35% of the height of the upper side of the freight container. The height of the end of the feeder belt is here very preferably considered.

Another preferred embodiment of the placement system has a feeder belt, which in the handling area is arranged at least partially at a height lying between 20% and 90% of the height of the upper side of the freight container. The end of the feeder belt is here preferably considered and regarded as relevant for the height indication. In a very preferred embodiment, the height of the feeder belt, especially preferably the end of the feeder belt, is between 30% and 80% of the height of the upper side of the freight container. The height of the feeder belt is especially preferably at 40% to 60% of the height of the upper side of the freight container.

In a preferred embodiment of the placement system, the end of the feeder belt has a variable height. It can thus change its distance from the floor. In this way, different freight containers, so-called unit load devices (ULD), or different baggage carts, so-called ramp carts, can be taken into account.

In a preferred embodiment, the placement system comprises a camera, so as to optically capture the baggage items to be loaded into the freight container. The camera is preferably arranged in such a way as to be pointed at the end of the feeder belt and take pictures of the end of the feeder belt, preferably with the corresponding baggage items. In this way, the baggage items to be loaded can be easily detected, and the placement machine can be correspondingly actuated. In addition, the transfer of the baggage item from the feeder belt to the placement machine can be monitored, and a proper and reliable transfer can be ensured.

Of course, several cameras can be used to monitor the baggage items in the placement system. Additional cameras can be provided, for example to monitor the handling area and detect an intrusion of people or objects. It is preferably also possible to monitor the presence and exact positioning of a freight container in the container area of the handling area.

The placement system can thus preferably comprise one or several other cameras, some or all of which can be pointed at the container area, for example to preferably take pictures inside of a freight container arranged in the container area. In this way, the arrangement of baggage items in the freight container can be recognized and detected. For example, these data can be used to glean information about which baggage is stored at which location inside of the freight container. This may be important given the nonappearance of a flight passenger when the baggage must again be removed from one of the freight containers afterwards.

A preferred embodiment of a placement system has a luggage detection unit, with which baggage items can be detected and preferably categorized at the end of the feeder belt. The baggage detection unit can here comprise a camera, which preferably is one of the cameras arranged in the placement system. At any point in time during the placement of baggage items on the freight container, the baggage detection unit makes it possible to exactly determine and know the location and identity of the individual baggage items.

A control unit is part of a preferred embodiment of a placement system. In this placement system, the control unit or loading control unit is used, and designed and set up to detect free places inside of a freight container that is to be loaded or filled based on camera images of a camera. Free spaces or unoccupied spaces inside of the freight container in which a baggage item can be positioned are here designated as free places.

The control unit can preferably be designed to control the placement machine in such a way that a baggage item that has been picked up, i.e., removed from the feeder belt, is placed inside of the freight container, preferably in a free space.

The interplay between the baggage detection unit, camera and control unit enables an optimized loading of a freight container with the delivered baggage items. Loading can here take place according to prescribed criteria, for example large and heavy baggage items in the lower area and smaller and lighter baggage items in the upper area. Smaller free spaces can also be filled in with smaller baggage items to achieve a stability in the freight container, so that the baggage items do not fall down or shift around inside of the container. It is likewise possible to place baggage items on the freight container based on prescribed criteria like capacity utilization or weight distribution.

In a preferred embodiment, the control unit comprises an AI unit that generates control instructions for the placement machine based on artificial intelligence and/or on self-learning programs and transmits them to the placement machine, for example a robot. In this way, an optimized placement of a freight container within the container area can be enabled. The AI unit can be already trained or trained by means of the placement system. By learning various placement configurations, the placement process can be further improved and accelerated.

The invention will be described and explained in more detail below based on several selected exemplary embodiments in conjunction with the attached drawings. Shown on:

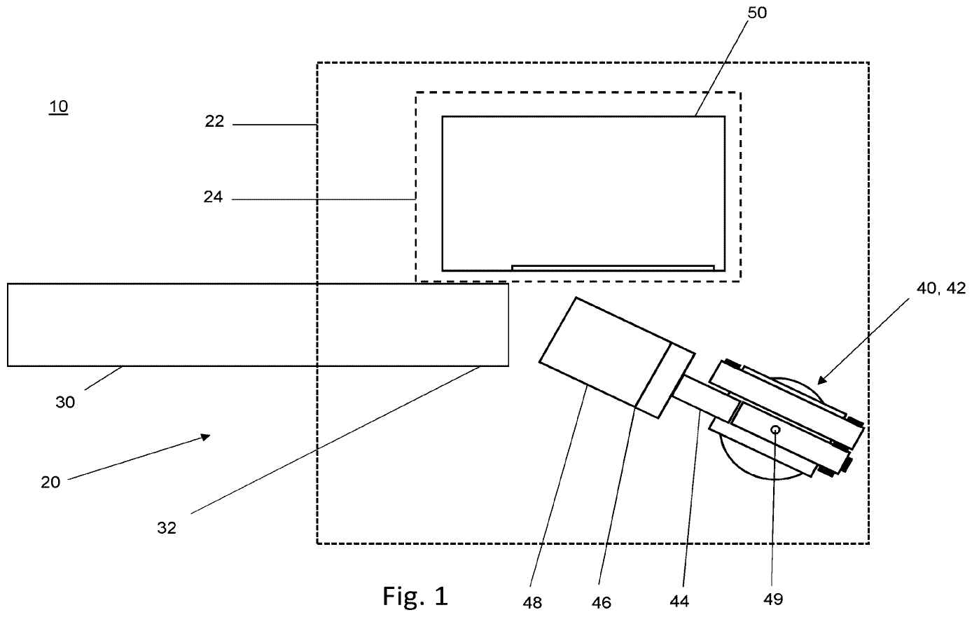

FIG. 1 is a schematic sketch of the placement system according to the invention;

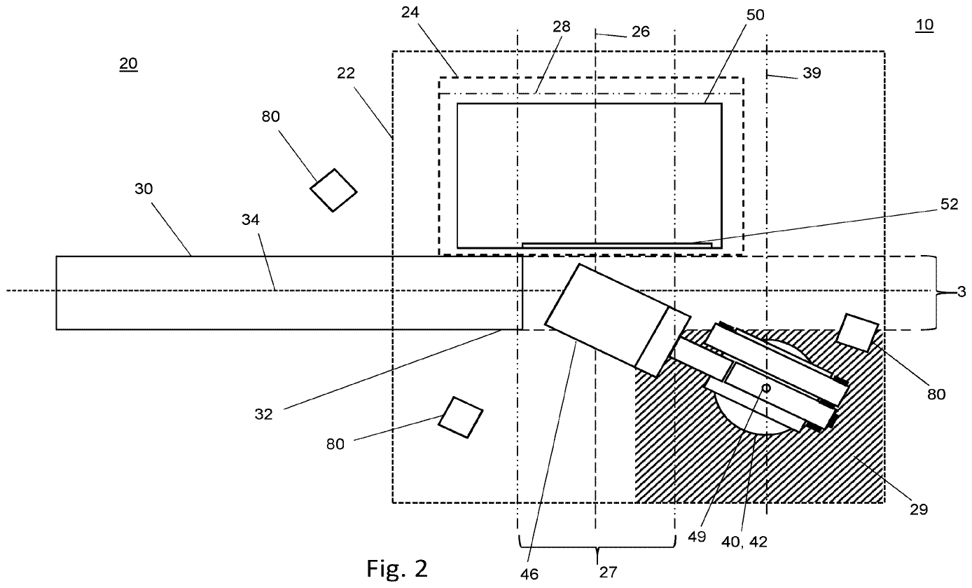

FIG. 2 is another schematic sketch of the placement system according to FIG. 1;

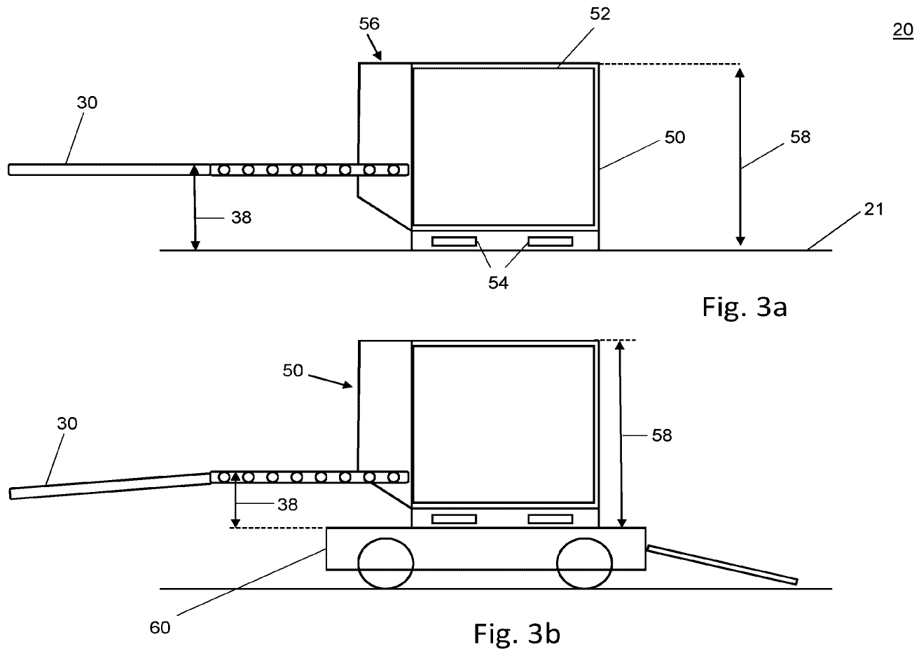

FIGS. 3a, 3b is a side view of the feeder belt and a freight container;

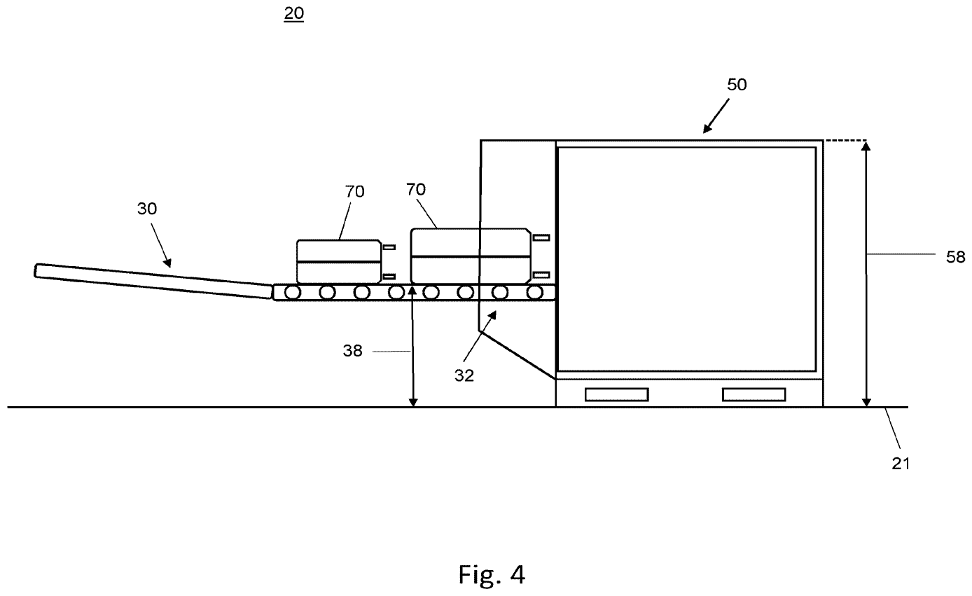

FIG. 4 is another side view of the feeder belt and the freight container;

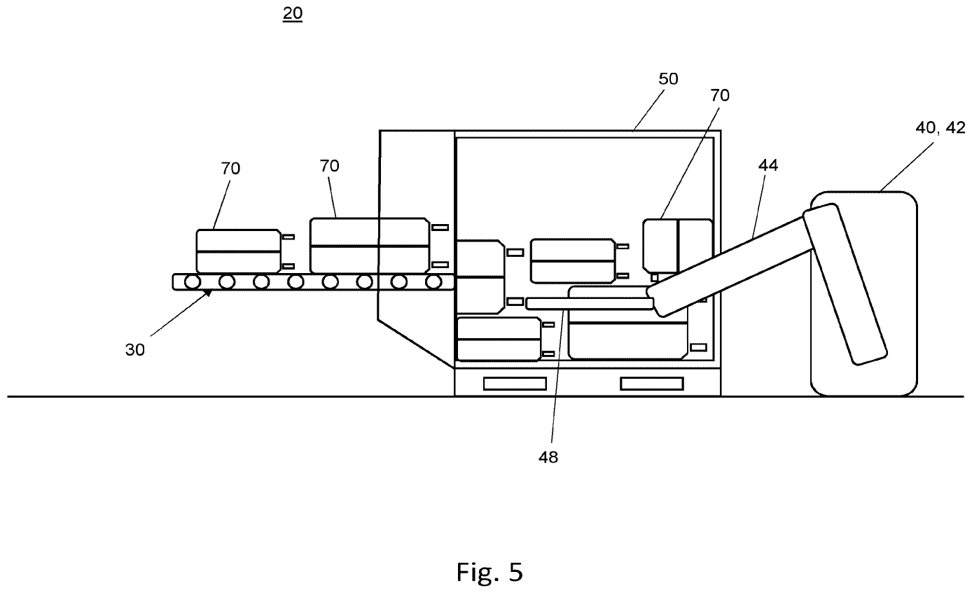

FIG. 5 is a placement situation of a placement system with freight container; and

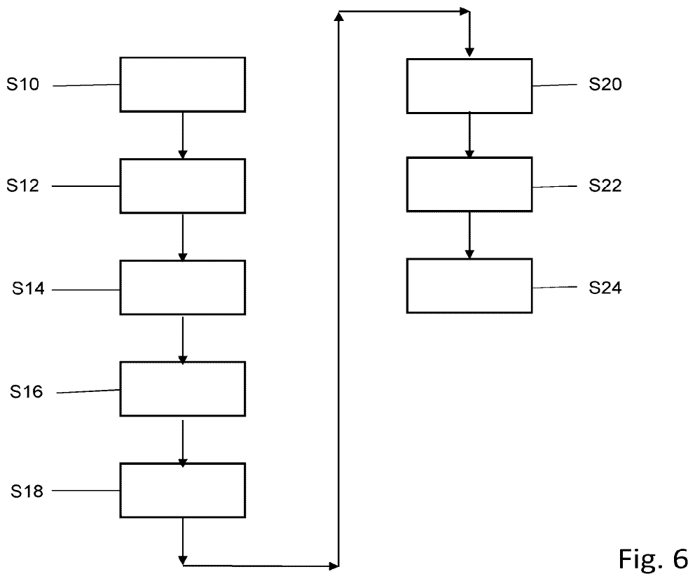

FIG. 6 is a schematic view of the sequence of the placement method according to the invention.

FIG. 1 shows a system 10 comprising a placement system 20 and a freight container 50 of the kind typically used at airports to load baggage items from passengers into an aircraft. Various types of so-called unit load devices (ULD) are here used, i.e., a device in or on which the baggage can be placed until it is loaded into aircraft. Typical freight containers (ULD's) are here containers which have one partially slanted side wall, thereby enabling a space-saving accommodation of this container in the aircraft. Such containers typically have a roof, and are filled by way of a side hatch. Other containers can in turn lack a roof, but still have a side opening or recess for holding the luggage. In addition, so-called ramp carts are also known. These are understood as a wagon on which the baggage can be loaded, and which is then moved by means of a towing vehicle. Baggage items are either loaded directly onto the ramp cart, or it can also be used for holding the freight container.

The placement system 20 at an airport comprises a feeder belt 30, so as to transport baggage items, and a placement machine 40, which is preferably a robot 42. The robot 42 shown here is designed as a 6-axis robot, and has a gripper 46 on its robot arm 44 at the free end in the form of a tray-like baggage rack 48. Such baggage racks 48 are known in prior art, and often designed as a belt conveyor, so as to move the baggage items on the baggage rack 48.

The placement system 20 further comprises a holding area 22, into which a free end 32 of the feeder belt 30 protrudes. Provided in the handling area 22 is a container area 24, in which the freight container 50 is placed and arranged for placement and loading, or also for a removal of baggage items.

The placement machine 40 is arranged inside of the handling area 22, but outside of the container area 24, wherein it moves around a vertical axis of rotation 49. Since the placement machine 40 or the robot 42 is stationarily fixed, it is designed as a 6-axis robot and has no seventh axis. For this reason, the positioning of the robot 42 within the handling area 22 is critical, so that the baggage items can be handled in the easiest, fastest and least energy requiring manner possible.

FIG. 2 shows the selection of position for the placement machine 40 or the robot 42 in more detail.

Based on the given space conditions at the airport, the handling area 22 is arranged at the end of the feeder belt 30. Its size is variable, and determined by the local circumstances. However, the handling area 22 is large enough that the handling area 22 comprises the end 32 of the feeder belt 30, the placement machine 40 and the container area 24 for holding the freight container 50.

The container area 24 in which the freight container 50 is positioned preferably extends to the side of the feeder belt 30 at its end 32. There can here be an overlap between the feeder belt 30 and the container area 24, as shown on FIG. 2. In this type of overlap, the container area 24 does not adjoin the feeder belt 30 (laterally offset), but the feeder belt 30 rather already extends laterally along the container area 24.

The position of the robot 42 is selected in such a way that the robot 42 or its base and its axis of rotation 49 are set up and placed outside of a perpendicular bisector 26 of the longitudinal expansion 28.

In a preferred embodiment, the robot 42 is arranged outside of a zone around the perpendicular bisector 26. The zone is preferably a perpendicular bisector corridor 27, the width of which preferably measures between 10% and 90% of the longitudinal expansion 28 of the container area 24, very preferably between 20% and 80%, further preferably between 30% and 70%, and especially preferably between 40% and 60%.

In addition, the placement machine 40 or the robot 42 is positioned outside and off-center to a longitudinal axis 34 of the feeder belt 30. In this way, an ideal position can be selected for the placement machine 40 or the robot 42.

It has preferably been shown that the alignment 36 of the feeder belt 32 is also kept, and the placement machine 40 is arranged outside of this alignment 36. The alignment 36 is here the imaginary elongation of the feeder belt 30 beyond its end 32.

In the embodiment shown here, use is made of a freight container 50 having a lateral placement opening 52, through which the baggage items can be loaded into the freight container 50. The robot 42 with its grippers 46 here picks up the baggage items that arrived at the end 32 of the feeder belt 30, and transports them through the placement opening 52 into the freight container 50 by pivoting and moving the robot arm 44.

During practical operation, it has proven advantageous for the placement machine 40 or robot 42 to be arranged within a partial area 29, which is defined by the perpendicular bisector 26 as well as the alignment 36 within the handling area 22. The partial area 29 is preferably somewhat smaller than the resultantly formed quadrant, preferably about as large as the partial area 29 shown hatched on FIG. 2.

The placement machine 40 or robot 42 is preferably arranged in such a way that the axis of rotation 49 lies on an imaginary line 39 running parallel to the perpendicular bisector 26, wherein this imaginary line 39 extends outside of the freight container 50. The robot 42 is further preferably positioned in such a way that this imaginary line 39 running parallel to the perpendicular bisector 26 extends through the axis of rotation 49 outside of the container area 24.

Positioning the robot 42 within the partial area 29 enables a quick, safe, reliable and energy-saving movement of the robot 42 with short movement paths, so as to pick up a baggage item from the feeder belt 30 and move it into the freight container 50.

The placement machine 20 preferably comprises at least one camera 80, so as to perform object monitoring. In the preferred embodiment according to FIG. 2, there is an arrangement of three cameras 80, which detect the baggage items on the feeder belt 30 on the one hand, and detect baggage items inside of the freight container 50 on the other. In this way, a controller can also be used to detect where free spaces and places are for placing the delivered baggage items inside of the freight container 50. The cameras 80 can be part of a baggage detection unit and/or part of a control unit, by means of which the placement system is controlled.

FIG. 3a shows the feeder belt 30 of the placement system 20 and a freight container 50 with a placement opening 52, wherein the freight container 50 is positioned within the container area 24 on the floor 21. The freight container 50 can be transported by means of a forklift truck, the forks of which engage into the two openings or recesses 54 in the floor area of the freight container 50.

The freight container 50 is arranged in such a way as to be positioned at the end 32 of the feeder belt 30, wherein the placement opening 52 preferably adjoins the feeder belt 30 in the direction of the longitudinal axis 34 of the feeder belt 30. The lateral part going beyond the floor length, i.e., the beveled part 56 with the chamfer, here preferably overlaps with the end 32 of the feeder belt 30.

The feeder belt 30 is preferably arranged in such a way that its height 38 calculated from the upper side to the floor 21 is smaller than the container height 58 between the upper edge of the freight container and the floor 21. In the embodiment shown here, the height 38 measures about 40% of the container height 58.

FIG. 3b shows a freight container 50, which likewise is an AKE type container of the kind used as standard in aviation. The freight container 50 is arranged on a trailer 60, with which it is moved at the airport and, for example, transported into the container area 24, where it can be placed for placement or loading purposes. Of course, the trailer 60 could also be a self-driving means of transportation, so that there is no need for a tractor unit for the trailer 60.

In the embodiment shown here, the feeder belt 30 has a multipart design, wherein the section with the end 32 can have a variable height. The additional section of the feeder belt 30 adjoining the latter can then run at an inclination in various positions of the end of the feeder belt 30, for example. For example, this can be realized by cardan shafts or supports not shown here.

In the embodiment shown here, the height 38 of the feeder belt 30 measures only about 25% of the container height 58, wherein the height 38 is here only defined up to the lower edge of the freight container 50.

The positioning of the feeder belt 30 according to both FIG. 3a and FIG. 3b enables a respective optimized loading of the freight container 50, because the baggage items picked up by the robot 42 only have to run through slight movements in height until their final placement inside of the freight container 50.

FIG. 4 likewise shows a side view of the placement system 20 with a type AKE freight container 50 and feeder belt 30. In this case, the section of the feeder belt 30 with the end 32 is lowered in relation to the remaining feeder belt 30, so that the section adjoining the end section is inclined. In this case, the height 38 of the feeder belt 30 at its end 32 measures about 45% of the height 58 of the freight container 50. The end section of the feeder belt 30 is preferably always horizontal, but can also have a slight tilt, as long as the baggage items 70 can still be safely and reliably transported on the feeder belt 30. In this case, removal by the robot 42 is improved.

However, it may also be advantageous under individual local circumstances that the feeder belt 30 in its end section with the end 32 be slanted, for example because the spatial conditions do not permit the baggage items 70 to be fed in a different way.

Finally, FIG. 5 shows another side view of the placement system 20 with its feeder belt 30 and the placement machine 40 in the form of a robot 42 with a robot arm 44 and tray-like baggage rack 48 at the end of the robot arm 44. Several baggage items 70 are delivered on the feeder belt b 30 one after the other, then loaded into the freight container 50 by means of the robot 42, and stacked on baggage items 70 already stowed in the freight container 50, for example.

FIG. 6 shows a schematic view of the sequence of the method according to the invention for automatically placing baggage items 70 from a feeder belt 30 on a freight container 50 at an airport. In a first step S10, a baggage item 70 at the end 32 of a feeder belt 30 is detected.

A step S12 involves positioning a baggage rack unit of a placement machine 40 in a pick-up position in proximity to the end 32 of the feeder belt 30. For example, the baggage rack unit can be the baggage rack 48 or a gripper 46.

In a pick-up step S14, a baggage item 70 is picked up from the feeder belt 30. A step S16 involves moving the baggage rack unit complete with the baggage item from the pick-up position into a feeding position in front of a loading opening or placement opening of a freight container, which is positioned in a container area within a handling area.

A step S18 involves detecting a free place or free space inside of the freight container, which is large enough and thus suitable for accommodating the baggage item picked up with the baggage rack unit.

In a step S20, the baggage rack unit or baggage rack of the robot 42 is moved from the feeding position outside of the freight container into a stacking position, so as to put down the baggage item in the detected free space. The stacking position can be entirely or partially inside of the freight container 50.

In a step S22, the baggage item 70 is put down in the freight container 50 at the detected free place.

In another step S24, the robot arm 44 with the baggage rack 48 is moved from the stacking position into a standby or intermediate position outside of the container area or directly into the pick-up position, so as to pick up another baggage item from the feeder belt.

The controller for performing the procedural steps according to the invention and additional steps for placing baggage items delivered by means of a feeder belt into a freight container can be implemented in a computer program product, which can be executed on a computer or some other processor unit.

The invention was comprehensively described and explained based on the drawings and the specification. The description and explanation are to be understood as exemplary, and not as limiting. The invention is not limited to the disclosed embodiments. Other embodiments or variations arise for the expert during the use of the present invention, as well as during a precise analysis of the drawings, the disclosure and the following claims.

In the claims, the words “comprise” and “with” do not rule out the presence of additional elements or steps. The indefinite article “a” or “an” does not rule out the existence of a plurality. An individual element or an individual unit can perform the functions of several of the units mentioned in the claims. A unit, a component, a device and a system can be partially or completely implemented in hardware and/or software. The mere mention of several measures in several different dependent claims must not be construed to mean that a combination of these measures cannot likewise be advantageously used. A computer program can be stored or distributed on a nonvolatile data carrier, and can be distributed together with hardware and/or as part of hardware, for example via the internet or hardwired or wireless communication systems. Reference numbers in the claims are not to be understood as limiting.

### REFERENCE LIST

10 System
20 Placement system
21 Floor
22 Handling area
24 Container area
26 Perpendicular bisector
27 Perpendicular bisector corridor
28 Longitudinal expansion
29 Partial area
30 Feeder belt
32 End
34 Longitudinal axis
36 Alignment
38 Height
39 Line
40 Placement machine
42 Robot
44 Robot arm
46 Gripper
48 Baggage rack
49 Axis of rotation
50 Freight container
52 Placement opening/loading opening
54 Recess
56 Beveled part
58 Container height
60 Trailer
70 Baggage item
80 Camera

1-16. (canceled)

17. A placement station for an airport for automatically loading a freight container with baggage items from a feeder belt, comprising
a feeder belt for feeding baggage items with one end;
a placement machine for picking up the baggage items from the feeder belt and transporting them into the freight container;
a handling area at the end of the feeder belt, into which the feeder belt extends and in which the placement machine is arranged;
a container area arranged within the handling area, in which the freight container is to be arranged and which has a prescribed length and width;
wherein
the placement machine is arranged stationarily fixed outside of the container area; and
the placement machine is arranged off-center to a longitudinal axis of the feeder belt and/or off-center to the perpendicular bisector of the longitudinal expansion of the container area for the freight container.

18. The placement station according to claim 17, wherein the placement machine is a robot.

19. The placement station according to claim 17, wherein the placement machine is a six-axis robot.

20. The placement station according to claim 17, wherein the placement machine is a robot with a grabber or with a baggage rack unit.

21. The placement station according to claim 17, wherein the placement machine is a robot with a tray-like baggage rack.

22. The placement station according to claim 17, wherein the placement machine is a robot that can be pivoted around a stationary vertical axis.

23. The placement station according to claim 22, wherein the pivoting angle for loading the freight container measures at most 240°.

24. The placement station according to claim 22, wherein the pivoting angle for loading the freight container measures at most 150°.

25. The placement station according to claim 22, wherein the pivoting angle for loading the freight container measures at most 120°.

26. The placement station according to claim 17, wherein the placement machine is arranged out of alignment with the feeder belt.

27. The placement station according to claim 17, wherein the feeder belt extends in the handling area at least partially at a height that is less than the height of the upper side of the freight container.

28. The placement station according to claim 17, wherein the feeder belt extends in the handling area at least partially at a height that is less than 80% of the height of the upper side of the freight container.

29. The placement station according to claim 17, wherein the feeder belt extends in the handling area at least partially at a height (height of the baggage item position on the belt) that is less than 50% of the height of the upper side of the freight container.

30. The placement station according to claim 17, wherein the feeder belt extends in the handling area at least partially at a height that is larger than the height of a lower loading edge of the freight container.

31. The placement station according to claim 17, wherein the feeder belt extends in the handling area at least partially at a height that is larger than 35% of the height of the upper side of the freight container.

32. The placement station according to claim 17, wherein the feeder belt in the handling area is at least partially at a height lying between 20% and 90% of the height of the upper side of the freight container,

33. The placement station according to claim 17, wherein the feeder belt in the handling area is at least partially at a height lying between 40% and 60% of the height of the upper side of the freight container.

34. The placement station according to claim 17, wherein the end of the feeder belt has a variable height.

35. The placement station according to claim 17, wherein the placement station comprises a camera, so as to optically capture the baggage items.

36. The placement station according to claim 17, wherein the placement station comprises a camera, wherein the camera is pointed at the end of the feeder belt, so as to take pictures of the end of the feeder belt.

37. The placement station according to claim 36, wherein the placement station comprises another camera, which is pointed at the container area so as to take pictures of the interior of a freight container arranged in the container area.

38. The placement station according to claim 17, wherein the placement station comprises a baggage detection unit, with which baggage items can be detected and categorized at the end of the feeder belt, wherein the baggage detection unit comprises a camera.

39. The placement station according to claim 17, wherein the placement station comprises a control unit, so as to detect free places for a baggage item inside of a freight container based on a camera image of a camera, and control the placement machine in such a way that a baggage item that has been picked up is placed inside of the freight container.

40. The placement station according to claim 17, wherein the control unit comprises an AI unit, so as to enable an optimized placement of a freight container within the container area.

41. A system for an airport for automatically loading a freight container with baggage items from a feeder belt, comprising a placement station according to claim 17 and a freight container to be filled, which is positioned within the container area.

42. A method for automatically placing baggage items from a feeder belt on a freight container at an airport, comprising the following steps:
detecting a baggage item at the end of the feeder belt;
positioning a baggage rack unit of a placement machine in a pick-up position in proximity to the end of the feeder belt;
picking up a baggage item from the feeder belt;
moving the baggage rack unit from the pick-up position into a feeding position in front of a loading opening of a freight container, which is arranged in a container area within a handling area;
detecting a free place for the picked-up baggage item inside of the freight container;
moving the baggage rack unit from the feeding position into a stacking position;
putting the baggage item down in the freight container.
